(19) United States
(12) Patent Application Publication
(10) Pub. No.: US 2021/0354300 A1
(43) Pub. Date: Nov. 18, 2021

(54) CONTROLLER, CONTROLLED APPARATUS, CONTROL METHOD, AND RECORDING MEDIUM

(71) Applicant: Preferred Networks, Inc., Tokyo (JP)

(72) Inventors: Manabu NAGAO, Tokyo (JP); Kota NABESHIMA, Tokyo (JP); Yuya UNNO, Tokyo (JP)

(21) Appl. No.: 17/443,548

(22) Filed: Jul. 27, 2021

Related U.S. Application Data
(63) Continuation of application No. PCT/JP2019/049803, filed on Dec. 19, 2019.

(30) Foreign Application Priority Data
Jan. 30, 2019 (JP) 2019-014743

(51) Int. Cl. B25J 9/16; G10L 15/00; G10L 25/78

(52) U.S. Cl. CPC B25J 9/1694; G10L 2025/783; G10L 25/78; G10L 15/00

(57) ABSTRACT

A controller includes at least one memory, and at least one processor. The at least one processor is configured to acquire speech, recognize the speech, determine whether the speech is uttered in a quiet voice, and control a movable part of a controlled apparatus in accordance with a result of the speech recognition. The at least one processor is configured to control the movable part of the controlled apparatus such that a sound pressure level of a sound generated by the movable part of the controlled apparatus is lower when it is determined that the speech is uttered in the quiet voice than when it is determined that the speech is not uttered in the quiet voice.

### CROSS-REFERENCE TO RELATED APPLICATIONS

This application is a continuation of International Application No. PCT/JP2019/049803, filed on Dec. 19, 2019 and designating the U.S., which claims priority to Japanese Patent Application No. 2019-014743, filed on Jan. 30, 2019. The contents of these applications are incorporated herein by reference in their entirety.

### BACKGROUND

### 1. Field of the Disclosure

The disclosures herein relate to a controller, a controlled apparatus, a control method, and a recording medium.

### 2. Description of the Related Art

A method for using linguistic information contained in speech to control an apparatus (such as a robotic apparatus) that includes a movable part is widely known. Further, a method for selecting an operation pattern of a controlled apparatus based on a combination of voice volume, pitch, and linguistic information is also known. However, a method for controlling a controlled apparatus by controlling sounds generated by a movable part of the controlled apparatus is not known.

### SUMMARY

It is desirable to provide a technology that controls sounds generated by a movable part of a controlled apparatus.

According to an aspect of the present disclosure, a controller includes at least one memory, and at least one processor. The at least one processor is configured to acquire speech, recognize the speech, determine whether the speech is uttered in a quiet voice, and control a movable part of a controlled apparatus in accordance with a result of the speech recognition. The at least one processor is configured to control the movable part of the controlled apparatus such that a sound pressure level of a sound generated by the movable part of the controlled apparatus is lower when it is determined that the speech is uttered in the quiet voice than when it is determined that the speech is not uttered in the quiet voice.

### BRIEF DESCRIPTION OF THE DRAWINGS

Other objects and further features of the present disclosure will be apparent from the following detailed description when read in conjunction with the accompanying drawings, in which:

FIG. 1 is a schematic view of a robotic apparatus according to an embodiment of the present disclosure;

FIG. 2 is a block diagram illustrating a hardware configuration of the robotic apparatus according to an embodiment of the present disclosure;

FIG. 3 is a block diagram illustrating a functional configuration of a controller according to an embodiment of the present disclosure;

FIG. 4 is an operating speed table specifying normal operating speeds and quiet operating speeds of movable elements according to an embodiment of the present disclosure;

FIG. 5 is a diagram illustrating operating speed patterns of a movable part in normal mode and quiet mode according to an embodiment of the present disclosure;

FIG. 6 is a block diagram illustrating a functional configuration of the controller according to another embodiment of the present disclosure;

FIG. 7 is a flowchart illustrating a control process for the robotic apparatus according to an embodiment of the present disclosure;

FIG. 8 is a schematic view of the robotic apparatus according to another embodiment of the present disclosure;

FIG. 9 is a diagram illustrating the priorities of movable elements according to an embodiment of the present disclosure;

FIG. 10 is a flowchart illustrating a control process for preferentially operating movable elements according to an embodiment of the present disclosure;

FIG. 11 is a flowchart illustrating a control process for the robotic apparatus according to another embodiment of the present disclosure;

FIG. 12 is a schematic view of a robotic apparatus according to a modification of the present disclosure; and

FIG. 13 is a diagram illustrating a hardware configuration of the controller according to an embodiment of the present disclosure.

### DESCRIPTION OF THE EMBODIMENTS

In the following, embodiments of the present disclosure will be described with reference to the accompanying drawings. In the following embodiments, a controller configured to control an apparatus such as a robotic apparatus will be disclosed.

### [Outline of the Present Disclosure]

A brief outline of the present disclosure will be described. The controller adjusts the operating speed of a movable part (including joints and an end effector) of a controlled apparatus (such as a robotic apparatus) based on paralinguistic information extracted from speech uttered by a user. Typically, the controller is embedded in the controlled apparatus, or the controller is provided outside the controlled apparatus and communicatively connected to the controlled apparatus. In the embodiments of the present disclosure, the paralinguistic information refers to the volume and pitch of a voice, a speaking rate, types of phonation, and the like. Examples of the types of phonation include a whispered voice and a breathy voice. The small voice and the whispered voice may be collectively referred to as a quiet voice. The small voice is defined as phonation in which sound power, excluding attenuation with respect to the distance between a sound collector (such as a microphone) of the controlled apparatus and the user, is less than or equal to a predetermined threshold. The whispered voice is defined as phonation in which the vocal folds do not vibrate. Similarly, a voice such as a yelling voice and a shouting voice may be referred to as a loud voice.

For example, if the user gives a command to the robotic apparatus to perform a desired operation in a quiet voice, the controller determines that the user's command is uttered in a quiet voice, and causes the movable part of the robotic apparatus to operate at a speed lower than a normal speed such that the robotic apparatus operates quietly.

If the user gives a command to the robotic apparatus to perform a desired operation in a loud voice, the controller determines that the user's command is uttered in a loud voice, and causes the movable part of the robotic apparatus at a speed higher than the normal speed.

In this manner, the controller according to the present disclosure can control the operation of the controlled apparatus such as a robotic apparatus based on paralinguistic information of speech uttered by the user.

### [Robotic Apparatus]

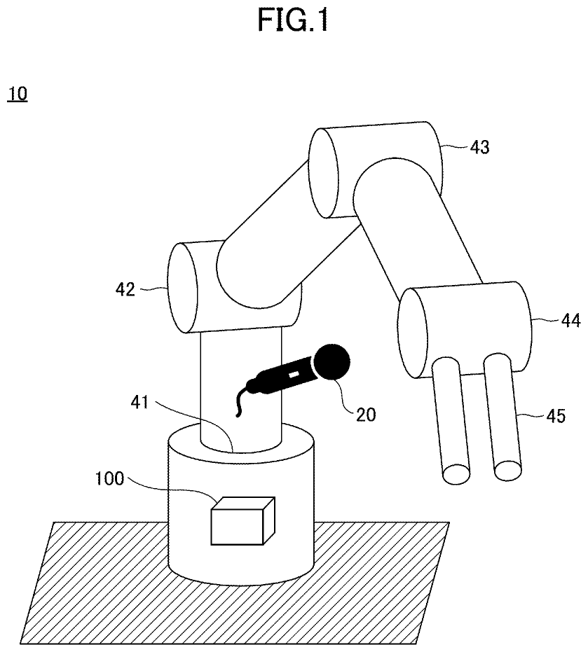

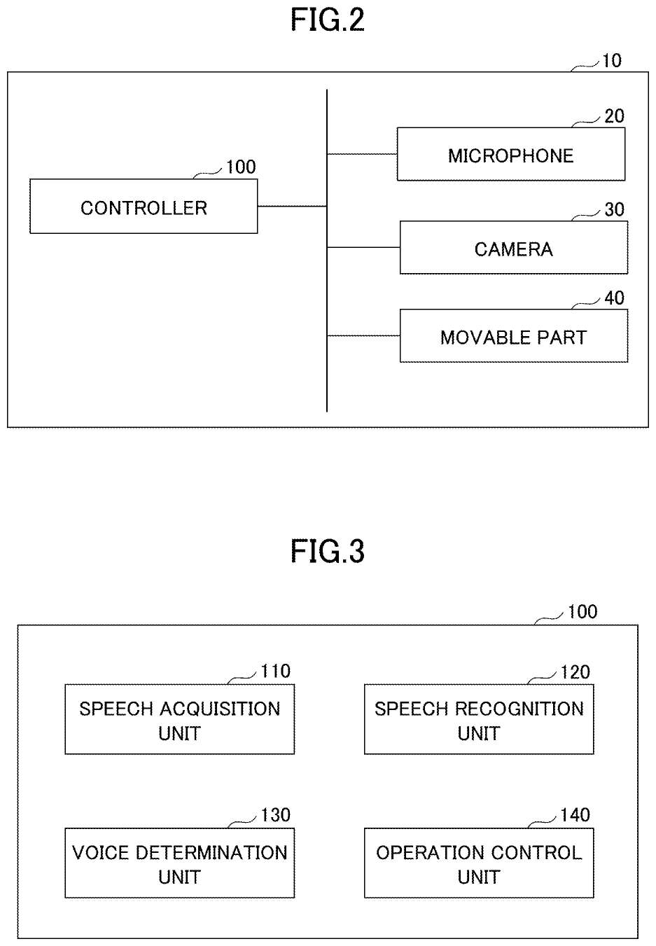

First, a robotic apparatus according to an embodiment of the present disclosure will be described with reference to FIG. 1 and FIG. 2. FIG. 1 is a schematic view of a robotic apparatus according to an embodiment of the present disclosure.

As illustrated in FIG. 1, a robotic apparatus 10 according to an embodiment of the present disclosure is capable of moving an object in accordance with a user's speech command. In the present embodiment, a controller 100 configured to control the operation of the robotic apparatus 10 is embedded in the robotic apparatus 10. Specifically, the robotic apparatus 10 uses a plurality of joints 41 through 44 and an end effector 45 (hereinafter referred to as “movable elements” or collectively referred to as a “movable part”) to grasp an object and move the object to a desired location in accordance with a user's speech command. Note that the configuration of the robotic apparatus 10 according to the present disclosure is not limited to a specific configuration described herein. The robotic apparatus 10 may be any apparatus that includes the movable part or the movable elements.

For example, as illustrated in FIG. 2, the robotic apparatus 10 includes a microphone 20, a camera 30, a movable part 40, and the controller 100.

The microphone 20 functions as a sound collector, and collects ambient sounds around the robotic apparatus 10 as well as speech uttered by the user. The microphone 20 transmits collected speech data to the controller 100. Note that the sound collector is not limited to the microphone 20, and the robotic apparatus 10 according to the present disclosure may include any type of sound collector. Although a single microphone 20 is depicted in the illustrated embodiment, the robotic apparatus 10 according to the present disclosure may include a plurality of sound collectors in order to perform array signal processing for sound source localization, sound source separation, and the like. Alternatively, the robotic apparatus 10 does not necessarily include a sound collector. In such a case, the robotic apparatus 10 may receive speech data or other data acquired by any other device.

The camera 30 functions as an image capturing device, and captures an image around the robotic apparatus 10. The camera 30 transmits captured image data to the controller 100. Note that the image capturing device is not limited to the camera 30, and the robotic apparatus 10 according to the present disclosure may include any type of image capturing device. Alternatively, the robotic apparatus 10 does not necessarily include an image capturing device. In such a case, the robotic apparatus 10 may receive image data or other data acquired by any other device.

The movable part 40 includes movable elements such as the joints 41 through 44 and the end effector 45. The joints 41 through 44 and the end effector 45 include respective actuators that operate the joints 41 through 44 and the end effector 45 as controlled by the controller 100. In general, when the movable elements are operated, operating sounds are generated by the movable elements. Examples of the operating sounds typically include sounds generated by the actuators themselves, sounds generated by movements of parts, cables, and exteriors other than the movable elements, and sounds generated by the contact between the end effector 45 and an object when the end effector 45 grasps the object.

The controller 100 controls the robotic apparatus 10. Specifically, the controller 100 controls components such as the microphone 20, the camera 30, and the movable part 40 as will be described later in detail. Specifically, in response to receiving a user's speech command collected by the microphone 20, the controller 100 acquires information indicating environmental conditions around the robotic apparatus 10 (such as image date indicating objects in the vicinity of the robotic apparatus 10) captured by the camera 30, creates an action plan for the movable part 40 based on the acquired environmental conditions and speech command, and controls the movable part 40 in accordance with the created action plan. Further, the controller 100 according to the embodiment determines whether the acquired speech command is uttered in a quiet voice, and adjusts the operating speed of the movable part 40 in accordance with the determined result.

Note that the robotic apparatus 10 according to the present disclosure is not restricted to the above-described hardware configuration, and may have any appropriate hardware configuration.

### First Embodiment

Next, the controller according to a first embodiment will be described with reference to FIG. 3 through FIG. 7. In the first embodiment, in a control process performed by the controller 100, a process for causing the robotic apparatus 10 to move an object will be mainly described. However, the control process performed by the controller 100 is not limited thereto. Further, it should be understood by those skilled in the art that the control process performed by the controller 100 may be applied to any other process in accordance with the application of the robotic apparatus 10.

FIG. 3 is a block diagram illustrating a functional configuration of the controller 100 according to an embodiment of the present disclosure. As illustrated in FIG. 3, the controller 100 includes a speech acquisition unit 110, a speech recognition unit 120, a voice determination unit 130, and an operation control unit 140.

The speech acquisition unit 110 acquires speech. Specifically, the speech acquisition unit 110 may acquire speech collected by a sound collector such as the microphone 20, speech stored in a memory, speech transmitted via a communication connection, or the like.

The speech recognition unit 120 recognizes the acquired speech. Specifically, the speech recognition unit 120 extracts speech data, representing the user's speech command, from the speech acquired by the speech acquisition unit 110, and performs a speech recognition process on the extracted speech data. The speech recognition process may be performed by using a known speech recognition technique to convert the speech data into text data. The speech recognition unit 120 transmits the recognition results (such as a text command, a character string, a speech feature vector, and a speech feature vector sequence), acquired from the speech data, to the operation control unit 140.

The voice determination unit 130 determines whether the speech is uttered in a quiet voice. As used herein, the term “quiet voice” is one or both of a whispered voice and a small voice. The voice determination unit 130 determines whether the user's speech command, acquired by the speech acquisition unit 110, is uttered in a whispered voice or in a small voice. As used herein, the “whispered voice” is defined as phonation in which the vocal folds do not vibrate. For example, a whispered voice can be detected by a known detection method described in “Robust Whisper Activity Detection Using Long-Term Log Energy Variation of Sub-Band Signal,” G. Nisha et al., IEEE SIGNAL PROCESSING LETTERS, VOL. 22, NO. 11, 2015, a detection method using pitch extraction results, or the like. Further, as used herein, the “small voice” is defined as phonation in which sound power, excluding attenuation with respect to the distance between the microphone 20 and the user, is less than or equal to a predetermined threshold. It is not necessary to consider the attenuation if it can be assumed that the distance between the microphone 20 and the user does not change significantly. That is, if the sound power of speech measured by the microphone 20 is less than or equal to a predetermined threshold, the speech may be regarded as being uttered in a small voice. The voice determination unit 130 transmits the determined result to the operation control unit 140.

The operation control unit 140 controls the movable part 40 of the robotic apparatus 10 in accordance with the speech recognition results. Further, the operation control unit 140 controls the robotic apparatus 10 such that the sound pressure level of a sound generated by the movable part 40 of the robotic apparatus 10 is lower when the voice determination unit 130 determines that the speech is uttered in a quiet voice than when the voice determination unit 130 determines that the speech is not uttered in a quiet voice. Specifically, the operation control unit 140 operates the movable part 40 of the robotic apparatus 10 in accordance with the speech recognition results such that the operating speed of the movable part 40 is lower when the voice determination unit 130 determines that the speech is uttered in a quiet voice than when the voice determination unit 130 determines that the speech is not uttered in a quiet voice.

For example, if the voice determination unit 130 determines that the user's speech command is not uttered in a quiet voice, the operation control unit 140 sets the operating mode of the robotic apparatus 10 to a normal mode. The normal mode may be a mode in which the operating speed (for example, the maximum value of the operating speed) of the movable part 40 is set to a normal operating speed. Conversely, if the voice determination unit 130 determines that the user's speech command is uttered in a quiet voice, the operation control unit 140 sets the operating mode of the robotic apparatus 10 to a quiet mode. The quiet mode may be a mode in which the operating speed (for example, the maximum value of the operating speed) of the movable part 40 is set to a quiet operating speed that is lower than the normal operating speed.

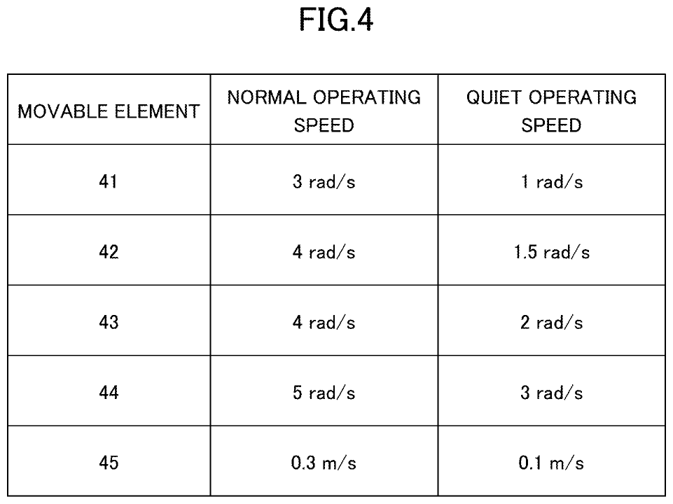

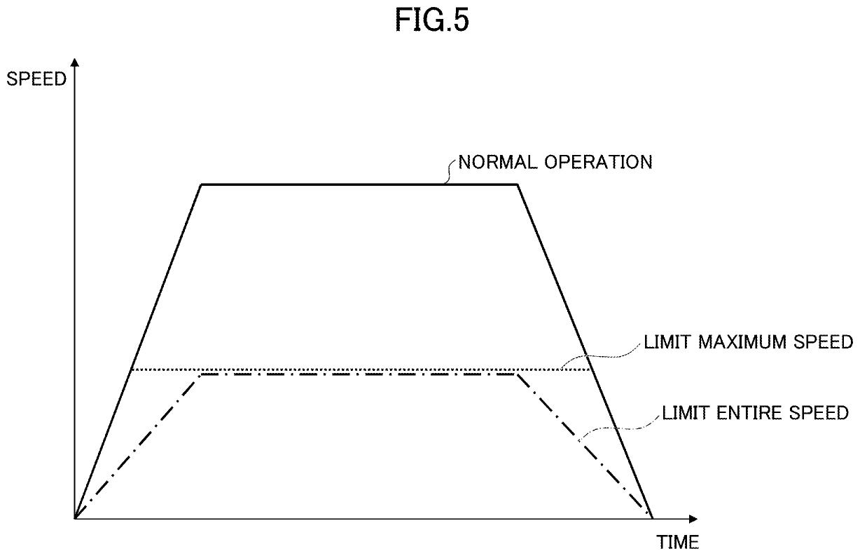

Further, as illustrated in FIG. 4, the operation control unit 140 may retain, in advance, an operating speed table that specifies the normal operating speeds and the quiet operating speeds of the movable elements (that is, the normal operating speed and the quiet operating speed of the movable part 40). The operation control unit 140 may set the operating speeds of the movable elements (that is, the operating speed of the movable part 40) based on the operating speed table. The operating mode of the robotic apparatus 10 can be changed by changing the operating speed of the movable part 40 with reference to the operating speed table. Note that adjusting the operating speed is not limited to setting the operating speed to the maximum value. That is, as illustrated in FIG. 5, the operating speed may be reduced to a fixed maximum value, or the operating speed may be entirely reduced.

The operation control unit 140 creates an action plan for the movable part 40 based on the maximum operating speed of the movable part 40 set as described above and the speech recognition results. Then, the operation control unit 140 operates the movable part 40 in accordance with the created action plan.

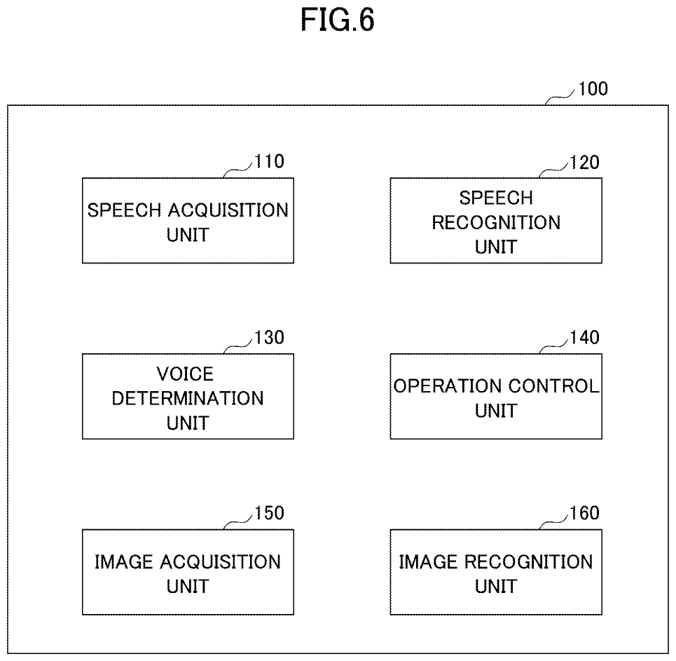

In another embodiment, as illustrated in FIG. 6, the controller 100 may further include an image acquisition unit 150 configured to acquire an image. Specifically, the image acquisition unit 150 acquires an image collected by the image capturing device, an image stored in a memory, an image transmitted via a communication connection, and the like. For example, in order to cause the robotic apparatus 10 to move an object, the operation control unit 140 may identify the name of an object and a designated location to which to move the object based on speech recognition results (including a text command) acquired by the speech recognition unit 120, and determine the object and the designated location in a physical space based on an image acquired by the image acquisition unit 150. Then, the operation control unit 140 creates an action plan for moving the object from the original location to the designated location at a set operating speed, and moves the object from the original location to the designated location by operating the movable part 40 in accordance with the created action plan.

In yet another embodiment, as illustrated in FIG. 6, the controller 100 may further include an image recognition unit 160 configured to recognize the acquired image. Specifically, the image recognition unit 160 performs an image recognition process on the image acquired by the image acquisition unit 150. For example, the image recognition process may be performed by utilizing any known image recognition technology, such as a Single Shot MultiBox Detector (SSD), that detects an object in the vicinity of the robotic apparatus 10 and estimates the name and the location of the detected object. The image recognition unit 160 transmits the recognition results (such as the name and the location of the object) acquired from the image, to the operation control unit 140.

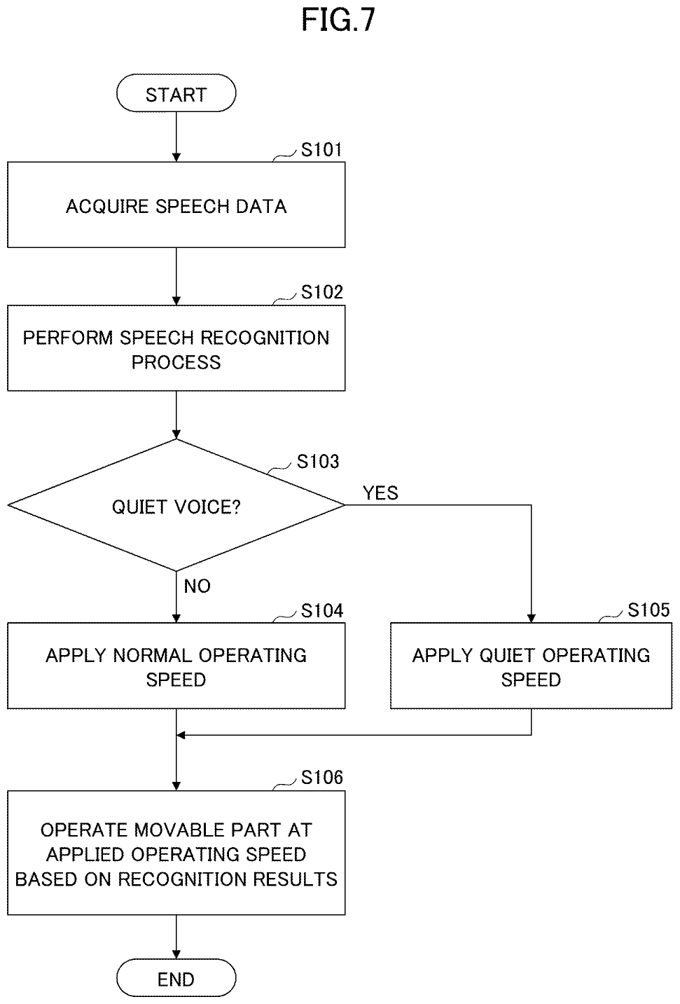

The above-described control process performed by the controller to cause the robotic apparatus 10 to move the object may be implemented by a flowchart as illustrated in FIG. 7. FIG. 7 is a flowchart illustrating a control process for the robotic apparatus according to an embodiment of the present disclosure. The controller 100 may start the control process in response to detecting a user's speech command. In FIG. 7, the image recognition process is used to detect an object to be moved; however, the image recognition process is not necessarily required for the control process as described above. For example, if a specific task is determined to be performed by an industrial machine or the like, the operation of the industrial machine or the like can be controlled in accordance with speech recognition results without acquiring an image and image recognition results.

As illustrated in FIG. 7, in step S101, the speech acquisition unit 110 acquires speech data. Specifically, the speech acquisition unit 110 acquires speech data representing a user's speech command from the microphone 20. Further, if the controller 100 includes the image acquisition unit 150, the image acquisition unit 150 may acquire image data, representing an image around the robotic apparatus 10, from the camera 30.

In step S102, the speech recognition unit 120 performs the speech recognition process on the acquired speech data. Specifically, the speech recognition unit 120 performs the speech recognition process on the acquired speech data, and converts the speech command into a text command. Further, if the controller 100 includes the image recognition unit 160, the image recognition unit 160 may perform the image recognition process on the acquired image data, and detects the location of an object in the vicinity of the robotic apparatus 10. The image recognition unit 160 may be configured to detect the name of the object.

In step S103, the voice determination unit 130 determines whether the acquired speech command is uttered in a quiet voice, namely determines whether the acquired speech command is uttered in a whispered voice or in a small voice. If the voice determination unit 130 determines that the speech command is not uttered in a quiet voice, but is uttered in a normal voice (no in S103), the operation control unit 140 applies the normal operating speed to the operating speed of the movable part 40 in step S104. Conversely, if the voice determination unit 130 determines that the speech command is uttered in a quiet voice (yes in S103), the operation control unit 140 applies the quiet operating speed that is slower than the normal operating speed to the operating speed of the movable part 40 in step S104.

In step S106, the operation control unit 140 creates an action plan based on the applied operating speed and the recognition results, and controls the movable part 40 in accordance with the created action plan. Specifically, the operation control unit 140 creates an action plan for performing the recognized speech command, and operates the movable part 40 at the applied operating speed in accordance with the action plan. Further, if the controller 100 includes the image acquisition unit 150, the operation control unit 140 may create an action plan for performing the recognized speech command based on the acquired image data, and operate the movable part 40 at the selected operating speed in accordance with the action plan. Further, if the controller 100 includes the image recognition unit 160, the operation control unit 140 may create an action plan for performing the recognized speech command based on the image recognition results, and operate the movable part 40 at the selected operating speed in accordance with the action plan.

Note that the operating speed of the movable part 40 is not limited to the above-described two discrete operating speeds, which are the normal operating speed and the quiet operating speed. The operating speed of the movable part 40 may be switched between three or more discrete or continuous operating speeds. For example, the robotic apparatus 10 may have three or more operating modes associated with levels of quietness, and operating speeds may be set in association with the respective operating modes. Alternatively, without discrete operating modes, continuous operating speeds may be set in association with levels of quietness. Further, a confidence level may be utilized. In order to calculate a confidence level, any existing technique such as binary classification probabilities may be used.

According to the first embodiment, an explicit command to quietly operate the robotic apparatus 10 does not need to be included in the contents of speech uttered by the user, and the controller 100 can operate the robotic apparatus 10 in quiet mode by determining whether the user's speech is uttered in a quiet voice.

### Second Embodiment

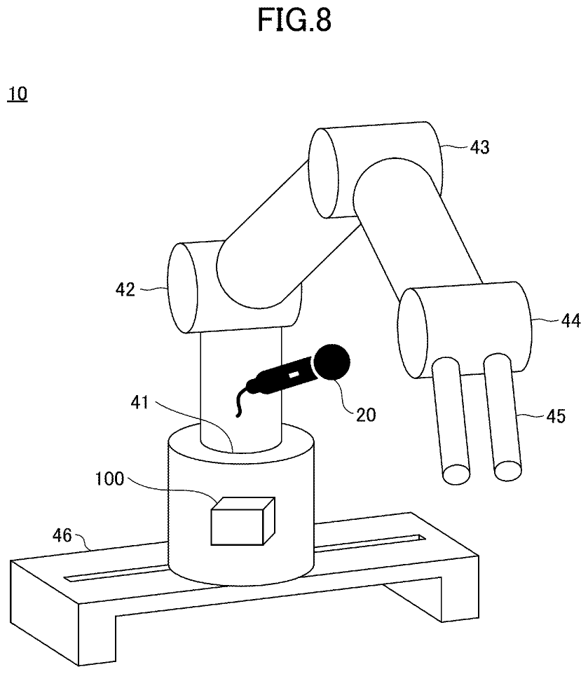

Next, the controller according to a second embodiment of the present disclosure will be described with reference to FIG. 8 through FIG. 10. In the above-described first embodiment, when it is determined that the user's speech command is uttered in a quiet voice, the robotic apparatus 10 is operated in quiet mode, and in the quiet mode, the operating speeds of the movable elements are set to the respective quiet operating speeds. In general, it is known that each movable element generates a different operating sound. For example, a movable element that causes the robotic apparatus 10 to move and a movable element to which a large load is applied tend to generate relatively loud operating sounds. Therefore, in the second embodiment, the controller 100 preferentially operates movable elements that have relatively quiet operating sounds. That is, the controller 100 determines an action plan for performing a task without operating movable elements that generate relatively loud operating sounds.

FIG. 8 is a schematic view of the robotic apparatus 10 that additionally includes a movable element 46 such that the entire robotic apparatus 10 can be moved in parallel.

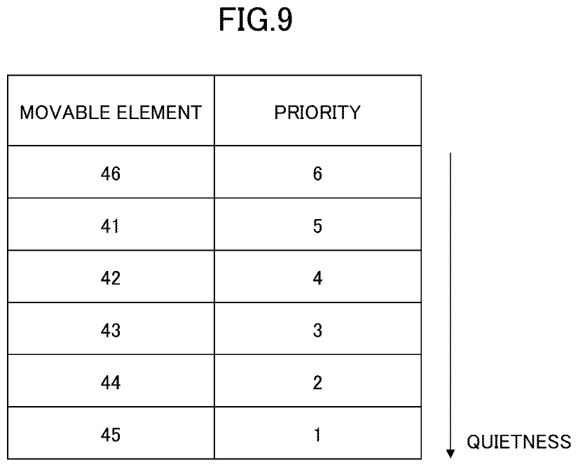

The operation control unit 140 retains, in advance, priority information indicating the priorities of movable elements as illustrated in FIG. 9. When the voice determination unit 130 determines that a user's speech command is uttered in a quiet voice, the operation control unit 140 creates an action plan for the movable part 40 based on the priority information and the recognition results obtained by the speech recognition unit 120. The priority information illustrated in FIG. 9 indicates that the movable element 45 having the first priority generates the quietest operating sound, and the movable element 46 having the sixth priority generates the loudest operating sound.

Specifically, when a user's speech command is uttered in a quiet voice, the operation control unit 140 determines whether a task instructed by the user (such as moving an object) can be performed by using only a movable element having the first priority. If the operation control unit 140 determines that the task can be performed by using only the movable element having the first priority, the operation control unit 140 creates an action plan for performing the task by operating the movable element having the first priority. Then, the operation control unit 140 operates the movable element in accordance with the action plan.

Conversely, if the operation control unit 140 determines that the task cannot be performed by using only the movable element having the first priority, the operation control unit 140 determines whether the task can be performed by using movable elements having the first and second priorities. If the task can be performed by using the movable elements having the first and second priorities, the operation control unit 140 creates an action plan for performing the task by operating the movable elements having the first and second priorities. Then, the operation control unit 140 operates the movable elements in accordance with the action plan. In this manner, the operation control unit 140 determines whether a combination of movable elements can achieve a task by adding a movable element having a higher priority until the operation control unit 140 has identified a combination that is capable of performing the task.

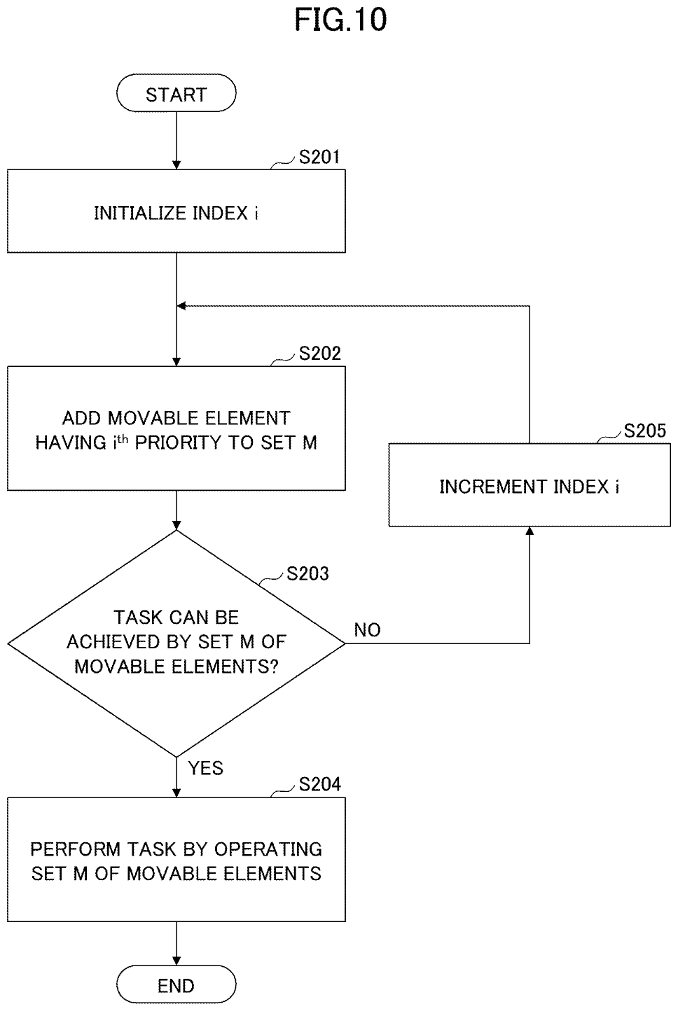

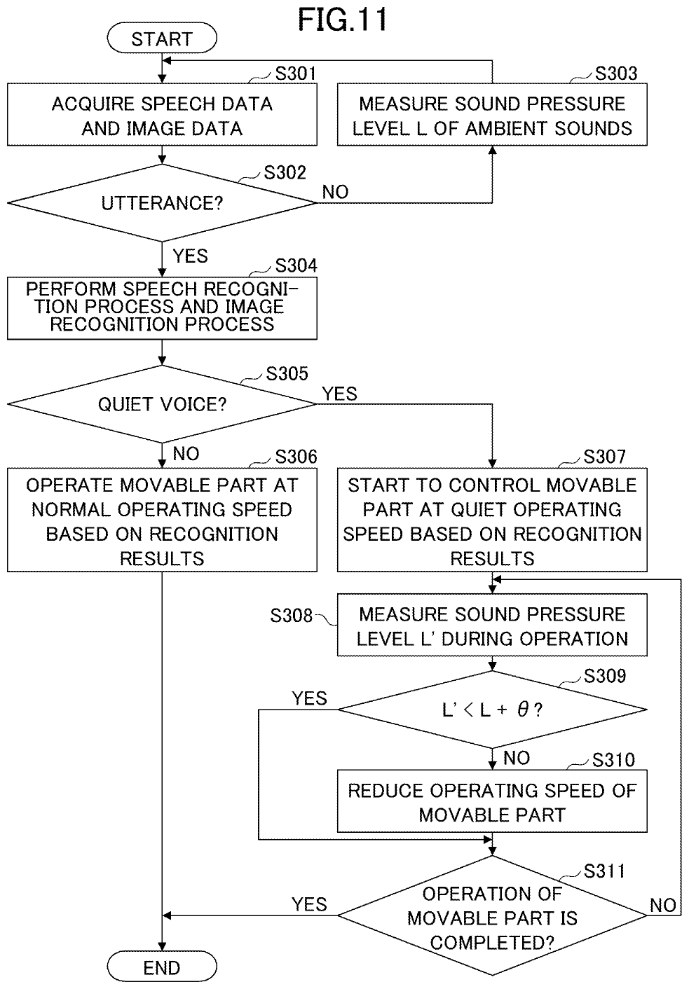

The above-described control process performed by the controller 100 to cause the robotic apparatus 10 to achieve a task may be implemented by a flowchart as illustrated in FIG. 10. The flowchart illustrated in FIG. 10 mainly describes the control of the movable part 40 when a user's speech command is uttered in a quiet voice. Steps for determining whether the user's speech command is uttered in a quiet voice and performing the speech recognition process performed by the speech recognition unit 120 are the same as steps S101 through 103, and the description thereof will not be repeated.

As illustrated in FIG. 10, in step S201, the operation control unit 140 initializes a priority index i to the highest priority (in this example, the index i is initialized to 1).

In step S202, the operation control unit 140 adds a movable element, of the movable part 40, having the i^{th} priority to a set M (combination) of movable elements. In this example, because the index i is initialized to 1, the operation control unit 140 adds a movable element having the first priority to the set M.

In step S203, the operation control unit 140 determines whether a task instructed by a user can be achieved by the set M of movable elements. For example, if the task is to move a specific object to a designated location, the operation control unit 140 may determine whether the end effector 45 can grasp the specific object and whether the grasped object can be moved to the designated location by operating the set M of movable elements.

If the operation control unit 140 determines that the task can be achieved by the set M of movable elements (yes in S203), the operation control unit 140 creates an action plan for performing the task by the set M of movable elements, and operates the set M of movable elements in accordance with the created action plan in step S204.

Conversely, if the operation control unit 140 determines that the task is cannot be achieved by the set M of movable elements (no in S203), the operation control unit 140 increments the index i by 1 in step S205, and returns to step S202.

Note that a set (combination) of movable elements of the movable part 40 that can achieve a task is not necessarily determined by the above-described method, and may be determined by any appropriate method. Further, the movable elements may be operated at respective normal operating speeds or quiet operating speeds. In this case, the priorities of the movable elements when operated in normal mode and the priorities of the movable elements when operated in quiet mode may be set.

According to the second embodiment, the operating sound of the entire robotic apparatus 10 can be reduced by preferentially operating movable elements that generate quiet operating sounds and stopping movable elements that generate loud operating sounds (that is, setting the operating speeds of movable elements that generate loud operating sounds to zero).

### Third Embodiment

Next, the controller according to a third embodiment of the present disclosure will be described with reference to FIG. 11. In the third embodiment, the operation control unit 140 controls the robotic apparatus 10 based on the sound pressure level of ambient sounds acquired by the speech acquisition unit 110. Specifically, while an action plan is performed, the controller 100 acquires the operating sound of the robotic apparatus 10 from the microphone 20. During this time, if a speech command is uttered in a quiet voice, the controller 100 controls the movable part 40 such that the sound pressure level of the operating sound is maintained at or below a predetermined value. That is, the operation control unit 140 acquires a sound in the vicinity of the robotic apparatus 10 while the movable part 40 is operated. During this time, if a speech command is uttered in a quiet voice, the operation control unit 140 controls the operation of the movable part 40 such that the sound pressure level of the acquired sound is less than a sound pressure level during non-operation of the movable part 40 plus a predetermined threshold, which corresponds to the amount of increase. Note that the configuration of the robotic apparatus 10 may be the same as that illustrated in FIG. 8.

The above-described control process may be implemented by a flowchart as illustrated in FIG. 11. FIG. 11 is a flowchart illustrating a control process for the robotic apparatus according to the third embodiment of the present disclosure. In the third embodiment, the image recognition process is performed to detect an object; however, the image recognition process is not necessarily required for the control process as described above.

As illustrated in FIG. 11, in step S301, the speech acquisition unit 110 and the image acquisition unit 150 acquire speech data and image data, respectively. Specifically, the speech acquisition unit 110 continuously acquires speech data, together with ambient sounds, from the microphone 20 regardless of whether the movable part 40 is operated. Therefore, the sound pressure level of ambient sounds, which is a sound pressure level during non-operation of the movable part 40, can be measured. Similarly, the image acquisition unit 150 continues to acquire image data representing an image around the robotic apparatus 10 from the camera 30.

In step S302, the speech recognition unit 120 determines whether the acquired speech data includes a speech command uttered by the user.

If the speech recognition unit 120 determines that the acquired speech data does not include a speech command uttered by the user (no in S302), in step S303, the operation control unit 140 measures a sound pressure level L of ambient sounds collected by the microphone 20. In general, even when the robotic apparatus 10 is not operated, there are some ambient sounds around the robotic apparatus 10. Therefore, when the operation control unit 140 measures the operating sound of the movable part 40 while the movable part 40 is operated, the operation control unit 140 needs to consider ambient sounds during non-operation of the movable part 40. Further, the operation control unit 140 may periodically measure the sound pressure level L of ambient sounds because the sound pressure level L of ambient sounds may change. After the sound pressure level L is measured, the process returns to step S301 such that the sound pressure level L is periodically measured.

Conversely, if the speech recognition unit 120 determines that the acquired speech data includes a speech command uttered by the user (yes in S302), the speech recognition unit 120 and the image recognition unit 160 perform the speech recognition process and the image recognition process, respectively, in step S304. Specifically, the speech recognition unit 120 performs the speech recognition process on the acquired speech data, and converts the speech command into a text command. The image recognition unit 160 performs the image recognition process on the acquired image data, and detects the location of each object around the robotic apparatus 10. The image recognition unit 160 may be configured to detect the name of each object.

In step S305, the voice determination unit 130 determines whether the acquired user's speech command is uttered in a quiet voice, namely determines whether the acquired speech command is uttered in a whispered voice or in a small voice.

If the voice determination unit 130 determines that the user's speech command is not uttered in a quiet voice, but in a normal voice (no in S305), the operation control unit 140 applies the normal operating speed to the operating speed of the movable part 40, creates an action plan for operating the movable part 40 at the normal operating speed based on the recognition results, and controls the movable part 40 in accordance with the action plan in step S306.

Conversely, if the voice determination unit 130 determines that the user's speech command is uttered in a quiet voice (yes in S305), the operation control unit 140 applies the quiet operating speed to the operating speed of the movable part 40, creates an action plan for operating the movable part 40 at the quiet operating speed based on the recognition results, and controls the movable part 40 in accordance with the action plan in step 307.

In step S308, the operation control unit 140 measures a sound pressure level L′ around the robotic apparatus 10. Although a description is not provided in the flowchart of FIG. 11, the microphone 20 collects ambient sounds around the robotic apparatus 10 including the operating sound of the movable part 40 while the movable part 40 is operated, and the operation control unit 140 measures the sound pressure level of the collected sounds.

In step S309, the operation control unit 140 determines whether the sound pressure level L′ around the robotic apparatus 10, including the operating sound, is less than the sound pressure level L of ambient sounds during non-operation of the movable part 40 plus a predetermined threshold θ. Specifically, if the sound pressure level L′ is less than L+θ, that is, L′<L+θ (yes in step S309), the operation control unit 140 determines that the amount of increase in sound pressure level due to the operating sound is maintained below the predetermined threshold θ. Accordingly, the operation control unit 140 maintains the current action plan, and causes the process to proceed to step S311.

Conversely, if the sound pressure level L′ is greater than or equal to L+θ, that is, L′≥L+θ (no in step S309), the operation control unit 140 determines that the amount of increase in sound pressure level due to the operating sound is too large, and adjusts an action plan such that the operating speed of the movable part 40 is reduced. Specifically, the operation control unit 140 reduces the operating speed of the movable part 40 by a small amount Δ. Alternatively, the operation control unit 140 may multiply the operating speed of the movable part 40 by Δ (<1). Further, the lowest value of the maximum operating speed of the movable part 40 may be determined in advance in order to prevent the robotic apparatus 10 from becoming inoperative. After the operating speed of the movable part 40 is adjusted based on the adjusted action plan, the process proceeds to step S311.

In step S311, the operation control unit 140 determines whether the operation of the movable part 40 based on the recognition results is completed. If the operation control unit 140 determines that the operation of the movable part 40 is completed (yes in S311), the operation control unit 140 ends the control process. Conversely, if the operation control unit 140 determines that the operation of the movable part 40 is not completed (no in S311), the operation control unit 140 causes the process to return to step S308, and determines whether the amount of increase in sound pressure level due to the operating sound of the movable part 40, which is operated based on the adjusted action plan, is maintained below the predetermined threshold θ.

In this manner, until the operation of the movable part 40 is completed, the operation control unit 140 continuously monitors the sound pressure level L′ by repeating steps S308 through S310 such that the condition L′<L+θ is satisfied.

Note that when the operation control unit 140 reduces the operating speed of the movable part 40 in S310, the operation control unit 140 may reduce the operating speeds of the movable elements separately. Alternatively, similar to the second embodiment, the operation control unit 140 may decrease the operating sound of the entire robotic apparatus by stopping or reducing the operating speeds of movable elements that generate loud operating sounds while operating movable elements that generate quiet operating sounds based on the priorities of the movable elements.

In one embodiment, the operation control unit 140 may set the operating speed of the movable part 40 to the quiet operating speed when a speech command is uttered in a quiet voice and also the sound pressure level L of ambient sounds is less than a predetermined value. In other words, even if a speech command is uttered in a quiet voice, the operation control unit 140 may set the operating speed of the movable part 40 to the normal operating speed when the sound pressure level L of ambient sounds during non-operation of the movable part 40 is greater than or equal to the predetermined value. Accordingly, the robotic apparatus 10 is not required to be operated in quiet mode when the sound pressure level L of ambient sounds during non-operation of the movable part 40 is greater than or equal to the predetermined value. In addition, even if a quiet voice is detected, the operation control unit 140 may operate the movable part 40 at the normal operating speed. In this case, the sound pressure level L′ while the movable part 40 is operated does not need to be measured.

Further, in one embodiment, the robotic apparatus 10 may be configured to include a plurality of microphones 20. In this case, the operation control unit 140 may use one of the plurality of microphones 20 to measure the sound pressure level of ambient sounds. Alternatively, the operation control unit 140 may use, as the sound pressure level of ambient sounds, the maximum value of sound pressure levels measured by the plurality of microphones 20. If the robotic apparatus 10 includes the N number of microphones 20₁ through 20_{N}, the operation control unit 140 may adjust the operating speed of the movable part 40 so as to satisfy maxᵢ (L′ᵢ−(Lᵢ+θ))<0, where Lᵢ denotes a sound pressure level measured by a microphone 20ᵢ (1≤ᵢ≤N) while the movable part 40 is not operated, and L′ᵢ denotes a sound pressure level measured by the microphone 20ᵢ while the movable part 40 is operated.

According to the third embodiment, the operating speed can be adjusted by considering ambient sounds during the operation of the robotic apparatus 10. In addition, the robotic apparatus 10 can be quietly operated only when the robotic apparatus 10 needs to be quietly operated.

### Fourth Embodiment

Next, the controller according to a fourth embodiment of the present disclosure will be described. In the fourth embodiment, the operation control unit 140 controls the robotic apparatus 10 in accordance with the distance between the robotic apparatus 10 and a speaker. Specifically, the voice determination unit 130 corrects the sound pressure level of speech in accordance with the distance between the robotic apparatus 10 and a user, and determines whether the collected speech is uttered in a quiet voice. Whether the speech is uttered in a small voice is determined based on whether the sound pressure level of the speech acquired by the microphone 20 is less than a predetermined value. For speech uttered at a distance far from the microphone 20, the sound pressure level of the speech decreases until reaching the microphone 20. For this reason, it would be difficult to determine whether speech is uttered in a small voice by simply measuring the sound pressure level of the speech with the microphone 20. Therefore, the voice determination unit 130 may correct the sound pressure level of speech in accordance with the distance between the user and the microphone 20.

The distance between the user and the microphone 20 may be estimated by any appropriate distance estimation method, such as a distance estimation method using a plurality of microphone arrays described in “Acoustic positioning using multiple microphone arrays”, Hui Liu and Evangelos Milios, The Journal of the Acoustical Society of America 117, 2772 (2005). Alternatively, the distance between the user and the microphone 20 may be estimated based on the size of the user's face acquired by the camera 30. Alternatively, the distance may be estimated by using a distance sensor, an infrared distance sensor, a laser distance sensor, or the like.

Further, attenuation coefficients used to correct a sound pressure level may be specified in advance. When the distance is estimated, the voice determination unit 130 may correct the sound pressure level measured by the microphone 20 based on an attenuation coefficient corresponding to the estimated distance, and determine whether the user's speech is uttered in a quiet voice based on the corrected sound pressure level.

According to the fourth embodiment, a sound pressure level can be appropriately corrected in accordance with the distance between the user and the microphone 20, and thus, a quiet voice can be appropriately determined based on the corrected sound pressure level.

### Fifth Embodiment

Next, the controller according to a fifth embodiment of the present disclosure will be described. In the fifth embodiment, the robotic apparatus 10 further includes a light emitting device, including a light source for illuminating the periphery of the robotic apparatus 10 and a display for providing information to a user. The operation control unit 140 controls the robotic apparatus 10 such that the amount of light emitted by the light emitting device is smaller when the voice determination unit 130 determines that speech is uttered in a quiet voice than when the voice determination unit 130 determines that the speech is not uttered in a quiet voice. Specifically, when the user gives a speech command in a quiet voice, the operation control unit 140 may cause the robotic apparatus 10 to operate in quiet mode, and cause the light emitting device to emit a smaller amount of light than when operating in normal mode or cause light to be turned off. Alternatively, when the user gives a speech command in a small voice or in a whispered voice, the operation control unit 140 may cause the robotic apparatus 10 to operate in quiet mode, and reduce the luminance of the display to be lower than that in normal mode or cause the display to be turned off. Note that the amount of light emitted by the light emitting device or the luminance of the display may be adjusted separately from or in conjunction with the adjustment of the operating speed of the movable part 40. Further, the operation control unit 140 may cause the light emitting device to emit different colors of light between the normal mode and the quiet mode.

According to the fifth embodiment, not only the operating sound but also the amount of light emitted by the robotic apparatus 10 can be reduced when the robotic apparatus 10 operates in a dark environment such as at night. Note that the operation control unit 140 may control the amount of light emitted by the robotic apparatus 10, without controlling the movable part of the robotic apparatus 10 in accordance with the determined result of the voice determination unit 130. Accordingly, a technology that controls the amount of light emitted by the controlled apparatus based on paralinguistic information of speech can be provided.

### Sixth Embodiment

Next, the controller according to a sixth embodiment of the present disclosure will be described. In the sixth embodiment, the speech acquisition unit 110 acquires speech from the sound collector, and the voice determination unit 130 determines whether the speech is uttered in a quiet voice. The robotic apparatus 10 can be moved by a moving unit such as wheels or feet (legs). If the voice determination unit 130 determines that the speech is uttered in a quiet voice, the operation control unit 140 switches the operating speed of the movable part 40 in accordance with the distance between the robotic apparatus 10 that is moving and the user. Specifically, when the robotic apparatus 10 is able to be moved and speech is uttered in a quiet voice by the user located in the vicinity of the robotic apparatus 10, the operation control unit 140 first operates the movable part 40 at the quiet operating speed. Then, when the robotic apparatus 10 is moved away from the user, the operation control unit 140 operates the movable part 40 at the normal operating speed. For example, similar to the above-described first embodiment, if the user utters speech in a quiet voice, the operation control unit 140 decreases the maximum operating speed vₘₐₓ of the movable part 40 to the quiet operating speed v_{whisper}. Subsequently, upon the distance d between the robotic apparatus 10 and the user or a location that receives the user speech exceeding a threshold d_{c}, the operation control unit 140 increases the maximum operating speed vₘₐₓ of the movable part 40 to the normal operating speed vₙₒᵣₘₐₗ (>v_{whisper}). That is, the operation control unit 140 controls the maximum operating speed vₘₐₓ in accordance with a formula below.

$${ν}_{max} = \{ \begin{matrix}{v}_{normal} & if d > {d}_{c} \\ {v}_{whisper} & if d \leq {d}_{c}\end{matrix} \qquad [ Formula 1 ]$$

Note that the normal operating speed vₙₒᵣₘₐₗ, the quiet operating speed v_{whisper}, and the threshold d_{c} may be different for each of the movable elements of the movable part 40. Alternatively, some of the normal operating speed vₙₒᵣₘₐₗ, the quiet operating speed v_{whisper}, and the threshold d_{c} may be common to the movable elements of the movable part 40. Alternatively, the normal operating speed vₙₒᵣₘₐₗ, the quiet operating speed v_{whisper}, and the threshold d_{c} may be common to some of the movable elements. Further, the operating speed according to the present disclosure is not required to be switched between the two discrete speeds, which are the normal operating speed and the quiet operating speed. The operating speed may be switched between three or more discrete or continuous operating speeds in accordance with the distance between the user and the robotic apparatus 10 that is moving. Further, after the robotic apparatus 10 is moved a predetermined distance away from the user or from a location that receives user speech, and the operating speed is set to the normal operating speed, the operation control unit 140 may set the operating speed to the quiet operating speed again if the robotic apparatus 10 returns to a location within the predetermined distance from the user or from the location that receives user speech.

Alternatively, similar to the above-described third embodiment, if the user utters speech in a quiet voice, the operation control unit 140 sets the threshold θ, below which to maintain the amount of increase in sound pressure level due to the operating sound, to a quiet mode threshold θ_{whisper}. Subsequently, in response to the distance d between the robotic apparatus 10 and the user or a location that receives the speech exceeding a predetermined threshold d_{c}, the operation control unit 140 increases the threshold θ to a normal mode threshold θₙₒᵣₘₐₗ (>θ_{whisper}). That is, the operation control unit 140 controls the threshold θ in accordance with a formula below.

$$θ = \{ \begin{matrix}{θ}_{normal} & if d > {d}_{c} \\ {θ}_{whisper} & if d \leq {d}_{c}\end{matrix} \qquad [ Formula 2 ]$$

Note that the threshold θ is not necessarily set to the above-described two discrete values, and may be set to three or more discrete or continuous values. For example, if the threshold θ is set to a continuous value, θ=ad+b (where parameters a and b are predetermined constants) may be used.

In this manner, speech may be corrected in accordance with the distance between the sound collector and the speaker, and the voice determination unit 130 may determine whether the corrected speech is uttered in a small voice based on the volume of the corrected speech.

According to the sixth embodiment, the robotic apparatus 10 is operated in quiet mode when the robotic apparatus 10 is located near the user or at a location where a speech command is received, and the robotic apparatus 10 is operated in normal mode when the robotic apparatus 10 is moved away from the user or the location where the speech command is received. Accordingly, the robotic apparatus 10 can efficiently perform a task while maintaining quietness.

### Seventh Embodiment

Next, the controller according to a seventh embodiment of the present disclosure will be described. In the seventh embodiment, the operation control unit 140 controls the robotic apparatus 10 in accordance with whether speech is uttered in a quiet voice, which is determined by the voice determination unit 130, and with the current time. Specifically, the operation control unit 140 sets the operating speed of the movable part 40 to the quiet operating speed if the user's speech command is uttered in a quiet voice and also the current time is within a predetermined time period. For example, in the controller 100, the user presets a time period, such as late at night and early in the morning, during which the robotic apparatus 10 is to be operated in quiet mode. When the user utters a speech command in a quiet voice, the operation control unit 140 determines whether the speech command is uttered in the preset time period. If the operation control unit 140 determines that the speech command is uttered in the preset time period, the operation control unit 140 sets the operating speed of the movable part 40 to the quiet operating speed. Conversely, if the operation control unit 140 determines that the speech command is not uttered in the preset time period, the operation control unit 140 sets the operating speed of the movable part 40 to the normal operating speed.

According to the seventh embodiment, regardless of whether a speech command is uttered in a quiet voice, the robotic apparatus 10 is operated in normal mode within a time period other than the preset time period during which the robotic apparatus 10 needs to be operated in quiet mode. Accordingly, the robotic apparatus 10 can be efficiently operated.

### Eighth Embodiment

Next, the controller according to an eighth embodiment of the present disclosure will be described. In the eighth embodiment, the voice determination unit 130 determines whether speech is uttered at a slow speaking rate, and the operation control unit 140 controls the robotic apparatus 10 in accordance with whether the speech is uttered at a slow speaking rate. That is, the voice determination unit 130 determines whether speech is uttered at a slow speaking rate instead of or in addition to determining whether the speech is uttered in a quiet voice, and the operation control unit 140 operates the movable part 40 in accordance with whether the speech is uttered at a slow speaking rate and with the recognition results.

As used herein, the expression “speech is uttered at a slow speaking rate” means that the speaking rate of an utterance is slow. Specifically, the voice determination unit 130 calculates the number of phonemes or the number of morae per unit time based on the length of a phoneme sequence or a mora sequence and the length of an utterance acquired by the speech acquisition unit 110. Then, the voice determination unit 130 determines whether the number of phonemes or the number of morae is less than a predetermined threshold. If the calculated number of phonemes or the number of morae is less than the predetermined threshold, the voice determination unit 130 determines that a speech command is uttered at a slow speaking rate. If the calculated number of phonemes or the number of morae is greater than or equal to the predetermined threshold, the voice determination unit 130 determines that a speech command is not uttered at a slow speaking rate. The speaking rate varies from person to person. Therefore, a threshold may be set for each speaker. This can be accomplished by using a known speaker recognition technique to identify the person speaking, and using a threshold associated with the identified person speaking. A threshold for each speaker is calculated by using a speaker's speech input into the controller 100. For example, a threshold for a speaker x can be set by obtaining an average value of speaking rates of speech for the past period of time T, and subtracting a predetermined value from the average value. The value of T is any positive integer. An average value of speaking rates of speech uttered N times in the past may be used (N is a natural number).

Further, if a speech command is uttered in a quiet voice at a slow speaking rate, the operation control unit 140 may set the robotic apparatus 10 in quiet mode and operate the movable part 40 at a speed lower than the quiet operating speed.

According to the eighth embodiment, the robotic apparatus 10 can be operated in accordance with a speaking rate.

The above-described first embodiment through the eighth embodiment are not necessarily implemented separately, and two or more of the above-described embodiments may be combined and implemented. Further, in the above-described embodiments, the operating speed of the movable part 40 is switched between the two discrete speeds, which are the normal operating speed and the quiet operating speed. However, the operating speed of the movable part 40 is not limited thereto, and the operating speed of the movable part 40 may be switched between three or more discrete or continuous operating speeds. For example, in the robotic apparatus 10, three or more operating modes may be set in accordance with levels of quietness, and operating speeds associated with the respective operating modes may be set. Alternatively, without using such discrete operating modes, continuous operating speeds associated with levels of quietness may be set. Further, in the above-described embodiments, the expression “the voice determination unit 130 determines whether speech is uttered in a quiet voice” includes not only a case in which whether or not speech is uttered in a quiet voice is determined in a binary manner, but also a case in which the level of quietness of speech is calculated. If the voice determination unit 130 calculates the level of quietness of speech, the expression “the operation control unit 140 controls the controlled apparatus such that a sound pressure level of a sound generated by the movable part of the controlled apparatus is lower when the voice determination unit 130 determines that speech is uttered in a quiet voice than when the voice determination unit 130 determines that the speech is not uttered in a quiet voice” includes a case in which “the operation control unit 140 controls the controlled apparatus such that a sound pressure level of a sound generated by the movable part of the controlled apparatus is lower when the calculated level of quietness is high than when the calculated level of quietness is low”.

Further, the movable part 40 of the robotic apparatus 10 may include a movable element dedicated to the quiet mode (which may be more fragile, require a high cost for movement, or the like), and the use of the movable element dedicated to the quiet mode may be limited to when the robotic apparatus 10 operates in quiet mode.

### [Robotic Apparatus According to Modification]

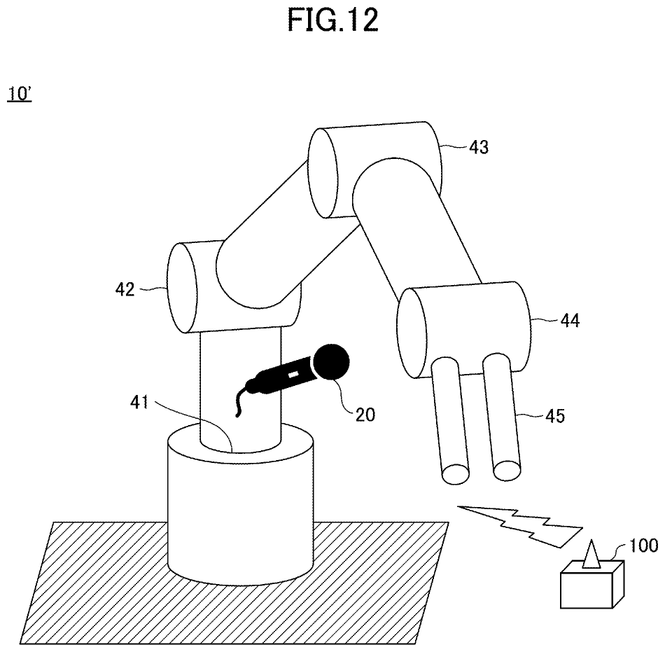

Next, a robotic apparatus according to a modification of the present disclosure will be described with reference to FIG. 12. FIG. 12 is a schematic view of a robotic apparatus according to a modification of the present disclosure.

As illustrated in FIG. 12, the controller 100 may be provided outside a robotic apparatus 10′. For example, the controller 100 may receive speech data and image data, acquired by the microphone 20 and the camera 30, respectively, via a wireless connection, and may transmit an instruction to operate the movable part 40 to the robotic apparatus 10′ via the wireless connection. The instruction to operate the movable part 40 is determined based on the acquired speech data and image data by a control process as described above. The robotic apparatus 10′ operates the movable part 40 in accordance with the received instruction. According to the modification, the controller 100 is not necessarily embedded in the robotic apparatus 10′, and the robotic apparatus 10′ may be remotely controlled by the controller 100 communicatively connected to the robotic apparatus 10′.

### [Hardware Configuration of Controller]

The functions of the controller 100 according to an embodiment may be implemented by one or more circuits that are configured by analog circuits, digital circuits, or analog-digital mixture circuits. In addition, a control circuit for controlling the functions may be provided. Each of the circuits may be an application-specific integrated circuit (ASIC), a field-programmable gate array (FPGA) or the like.

At least a part of the controller 100 may be configured by hardware, or may be configured by software executed by a central processing unit (CPU) or the like. If the controller 100 is configured by software, a program for implementing the controller 100 and at least a part of the controller 100 is stored in a recording medium, and the controller 100 may be implemented by loading the program into a computer. The recording medium is not limited to a removable medium such as a magnetic disk (such as a flexible disk) or an optical disc (such as a CD-ROM or a DVD-ROM), and may be a fixed-type recording medium such as a hard disk device and a solid-state drive (SSD) using a memory. In other words, information processing by software may be specifically implemented by hardware resources. In addition, the information processing by the software may be implemented by a circuit such as a FPGA and may be executed by hardware. A job may be performed by an accelerator such as a graphics processing unit (GPU).

For example, a computer can be used as the apparatus according to the above-described embodiments by causing the computer to read dedicated software stored in a computer-readable recording medium. The type of the recording medium is not particularly limited. Further, a computer can be used as the apparatus according to the above-described embodiments by causing the computer to install dedicated software downloaded via a communication network. In this manner, the information processing by the software is specifically implemented by hardware resources.

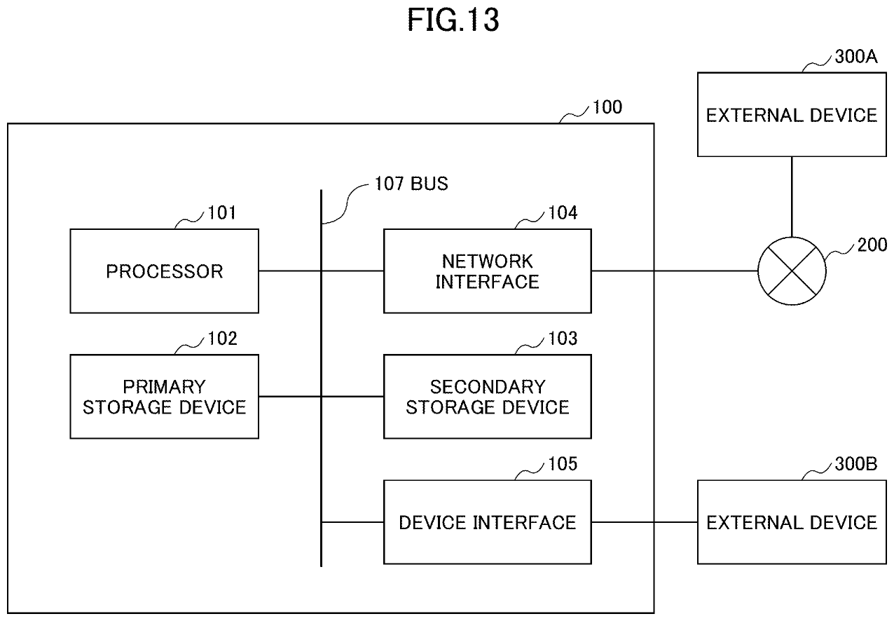

FIG. 13 is a block diagram illustrating an example of a hardware configuration according to an embodiment of the present disclosure. The controller 100 includes a processor 101, a primary storage device 102, a secondary storage device 103, a network interface 104, and a device interface 105. The controller 100 may be implemented as a computer device in which the above-described components are connected via a bus 260.

Note that the number of each of the components included in the controller 100 illustrated in FIG. 13 is one, but the number of each of the components included in the controller 100 may be plural. Further, the single controller 100 is illustrated in FIG. 13. However, software may be installed on a plurality of controllers 100, and each of the controllers 100 may perform a different part of a process of the software. In this case, the controllers 100 may communicate with each other via the network interface 104 or the like.

The processor 101 is an electronic circuit (such as a processing circuit or a processing circuitry) including a control unit and an arithmetic device of the controller 100. The processor 101 performs an arithmetic process based on a program and data input from devices included in the controller 100, and outputs an arithmetic result or a control signal to the devices. Specifically, the processor 101 may control the components included in the controller 100 by executing an operating system (OS) of the controller 100, an application, or the like. The processor 101 is not particularly limited as long as the above-described process can be performed. The controller 100 and the components of the controller 100 are implemented by the processor 101. As used herein, the processing circuit may refer to one or more electronic circuits disposed on one chip or may refer to one or more electronic circuits disposed on two or more chips or two or more devices. If multiple electronic circuits are used, the electronic circuits may communicate with each other in a wired manner or in a wireless manner.

The primary storage device 102 is a storage device that stores commands executed by the processor 101 and various types of data. Information stored in the primary storage device 102 is read by the processor 101. The secondary storage device 103 is a storage device other than the primary storage device 102. These storage devices may be any electronic components that can store electronic information, and may be memories or storage devices. The memories may be either volatile memories or non-volatile memories. A memory for storing various types of data in the controller 100 may be implemented by the primary storage device 102 or the secondary storage device 103. For example, at least a part of the memory may be provided in the primary storage device 102 or the secondary storage device 103. As another example, if an accelerator is included, the at least part of the memory may be provided in a memory of the accelerator.

The network interface 104 is an interface for connecting to a communication network 200 in a wireless manner or in a wired manner. The network interface 104 may be any interface conforming to existing communication standards. The network interface 104 may exchange information with an external device 300A that is communicatively connected via the communication network 200.

The external device 300A may be a camera, a motion capture device, an output device, an external sensor, an input device, or the like. Further, the external device 300A may be a device having some functions of the components of the controller 100. Further, similar to a cloud service, the controller 100 may receive some processing results of the external device 300A via the communication network 200.

The device interface 105 is an interface, such as a universal serial bus (USB) that is directly connected to an external device 300B. The external device 300B may be an external recording medium or a storage device. The memory may be implemented by the external device 300B.

The external device 300B may be an output device. The output device may be a display device that displays an image, or may be a device that outputs sounds. The examples of external device 300B include a liquid crystal display (LCD), a cathode-ray tube (CRT), a plasma display panel (PDP), an organic electro-luminescence (EL) display, and a speaker.

The external device 300B may be an input device. The input device may include devices such as a keyboard, a mouse, a touch panel, and a microphone, and provides information input from these devices to the controller 100. A signal from the input device is output to the processor 101.

The speech acquisition unit 110, the speech recognition unit 120, the voice determination unit 130, the operation control unit 140, the image acquisition unit 150, and the image recognition unit 160 of the controller 100 according to the above-described embodiments may be implemented by the processor 101. Further, the memory of the controller 100 may be implemented by the primary storage device 102 or the secondary storage device 103. Further, the controller 100 may include one or more memories.

As used herein, the phrase “at least one of a, b, and c” not only means “a”, “b”, “c”, “a and b”, “a and c”, “b and c”, “a, b, and c”, or any combination thereof, but may also mean a combination of a plurality of same elements such as “a and a”, “a, b, and b”, “a, a, b, b, c, and c”. Further, the phrase “at least one of a, b, and c” may mean a combination including an element other than “a”, “b”, and “c”, such as a combination of “a, b, c, and d”.

Similarly, as used herein, the phrase “at least one of a, b, or c” not only means “a”, “b”, “c”, “a and b”, “a and c”, “b and c”, “a, b, and c”, or any combination thereof, but may also mean a combination of a plurality of same elements such as “a and a”, “a, b, and b”, “a, a, b, b, c, and c”. Further, the phrase “at least one of a, b, or c” may mean a combination including an element other than “a”, “b”, and “c”, such as a combination of “a, b, c, and d”.

Although specific embodiments have been described above, the claimed subject matter is not limited to the above-described embodiments. Variations and modifications may be made without departing from the scope of the present invention.

What is claimed is:

1. A controller comprising:
at least one memory; and
at least one processor configured to:
acquire speech,
recognize the speech,
determine whether the speech is uttered in a quiet voice, and
control a movable part of a controlled apparatus in accordance with a result of the speech recognition,
wherein the at least one processor is configured to control the movable part of the controlled apparatus such that a sound pressure level of a sound generated by the movable part of the controlled apparatus is lower when it is determined that the speech is uttered in the quiet voice than when it is determined that the speech is not uttered in the quiet voice.

2. The controller according to claim 1, wherein the at least one processor is configured to control the movable part of the controlled apparatus such that an operating speed of the movable part of the controlled apparatus is lower when it is determined that the speech is uttered in the quiet voice than when it is determined that the speech is not uttered in the quiet voice.

3. The controller according to claim 1, wherein the at least one processor is configured to stop at least one movable element of the movable part of the controlled apparatus when it is determined that the speech is uttered in the quiet voice.

4. The controller according to claim 1, wherein the at least one processor is configured to acquire a sound pressure level of an ambient sound, and control the movable part of the controlled apparatus in accordance with the acquired sound pressure level of the ambient sound.

5. The controller according to claim 1, wherein the at least one processor is configured to control a light emitting device of the controlled apparatus such that an amount of light emitted by the light emitting device of the controlled apparatus is smaller when it is determined that the speech is uttered in the quiet voice than when it is determined that the speech is not uttered in the quiet voice.

6. The controller according to claim 1, wherein the at least one processor is configured to control the movable part of the controlled apparatus in accordance with a distance between the controlled apparatus and a speaker of the speech.

7. The controller according to claim 1, wherein the at least one processor is configured to acquire the speech from a sound collector, and determine whether the speech is uttered in the quiet voice in accordance with a distance between the sound collector and a speaker of the speech.

8. The controller according to claim 1, wherein the at least one processor is configured to control the movable part of the controlled apparatus in accordance with whether the speech is uttered in the quiet voice and with a current time.

9. The controller according to claim 1, wherein the at least one processor is configured to determine whether the speech is uttered at a slow speaking rate, and control the movable part of the controlled apparatus in accordance with whether the speech is uttered at the slow speaking rate.

10. The controller according to claim 1, wherein the quiet voice is a whispered voice.

11. The controller according to claim 1, wherein the quiet voice is a small voice.

12. The controller according to claim 11, wherein the at least one processor is configured to acquire the speech from a sound collector, correct a power of the speech in accordance with a distance between the sound collector and a speaker of the speech, and determine whether the speech is uttered in the small voice based on the corrected power of the speech.

13. The controller according to claim 1, wherein the at least one processor is configured to determine that the speech is uttered in the quiet voice when a power of the speech is less than a threshold.

14. A controlled apparatus comprising,
the controller according to claim 1.

15. A control method performed by at least one processor, the method comprising:
acquiring speech;
recognize the speech;
determining whether the speech is uttered in a quiet voice; and
controlling a movable part of a controlled apparatus in accordance with a result of the speech recognition, and
wherein the at least one processor is configured to control the movable part of the controlled apparatus such that a sound pressure level of a sound generated by the movable part of the controlled apparatus is lower when it is determined that the speech is uttered in the quiet voice than when it is determined that the speech is not uttered in the quiet voice.

16. The control method according to claim 15, wherein the controlling of the movable part of the controlled apparatus includes controlling the movable part of the controlled apparatus such that an operating speed of the movable part of the controlled apparatus is lower when it is determined that the speech is uttered in the quiet voice than when it is determined that the speech is not uttered in the quiet voice.

17. The control method according to claim 15, wherein the controlling of the movable part of the controlled apparatus includes stopping at least one movable element of the movable part of the controlled apparatus when it is determined that the speech is uttered in the quiet voice.

18. The control method according to claim 15, wherein the controlling of the movable part of the controlled apparatus includes acquiring a sound pressure level of an ambient sound and controlling the movable part of the controlled apparatus in accordance with the acquired sound pressure level of the ambient sound.

19. The control method according to claim 15, wherein the controlling of the movable part of the controlled apparatus includes controlling the movable part of the controlled apparatus in accordance with a distance between the controlled apparatus and a speaker of the speech.

20. A non-transitory recording medium having stored therein a program for causing at least one processor to execute a process comprising:
acquiring speech;
recognize the speech;
determining whether the speech is uttered in a quiet voice; and
controlling a movable part of a controlled apparatus in accordance with a result of the speech recognition,
wherein the controlling includes controlling the movable part of the controlled apparatus such that a sound pressure level of a sound generated by the movable part of the controlled apparatus is lower when it is determined that the speech is uttered in the quiet voice than when it is determined that the speech is not uttered in the quiet voice.
